(19) United States
(12) Patent Application Publication
(10) Pub. No.: US 2025/0334789 A1
(43) Pub. Date: Oct. 30, 2025

(54) DISTANCE-MEASURING TARGET AND BIRD WATCHING SCOPE

(71) Applicant: JINHUA LANHAI PHOTOELECTRICITY TECHNOLOGY CO.,LTD., JINHUA (CN)

(72) Inventors: Xiangwei QIAN, JINHUA (CN); Chongqiu LIU, JINHUA (CN)

(21) Appl. No.: 19/263,624

(22) Filed: Jul. 9, 2025

(30) Foreign Application Priority Data
May 27, 2025 (CN) 202510691560.4

(51) Int. Cl. G02B 23/00; G01S 7/481; G01S 7/51; G01S 17/08; G01S 17/88; G02B 23/04; G02B 27/34

(52) U.S. Cl. CPC G02B 23/145; G01S 7/4814; G01S 7/4816; G01S 7/51; G01S 17/08; G01S 17/88; G02B 23/04; G02B 27/34

(57) ABSTRACT

A distance-measuring target and bird watching scope includes a receiving optical path in which an objective lens group, a focusing objective lens, a reticle, a zoom front lens group, a zoom compensation lens group, a zoom rear lens group and a fixed eyepiece group are provided sequentially in the light beam propagation direction; a laser emitting system including a laser light emitting diode and an emitting lens provided in the emitting optical path propagation direction; a laser receiving system used to convert the optical signal in the receiving optical path into an electrical signal through a beam splitter prism, obtain the target distance and display through a liquid crystal display system; and a liquid crystal display system used to combine the display information containing the target distance to the receiving optical path through a beam splitter prism, and transmit to the fixed eyepiece group.

### CROSS REFERENCE TO RELATED APPLICATIONS

The present disclosure claims the priority to the Chinese patent application with the filing No. 2025106915604, entitled “DISTANCE-MEASURING TARGET AND BIRD WATCHING SCOPE” and filed on May 27, 2025 with the Chinese Patent Office, the contents of which are incorporated herein by reference in their entirety.

### TECHNICAL FIELD

The present disclosure relates to the technical field of target and bird watching scopes, and particularly to a target and bird watching scope with a distance measuring function.

### BACKGROUND ART

Spotting scopes (target watching scopes) and birdwatching scopes are a type of optical instruments used for long-distance observation and are used in military, tourism and other fields. However, most target and bird watching scopes on the market now only have telescope observation functions and cannot measure the observed targets. Especially for spotting scopes used in military training, if the distance to the target cannot be measured, the trajectory cannot be effectively proofread and corrected.

At present, the modification of the distance measuring of the spotting scope and the birdwatching scope are all based on the addition of an external distance measuring sensor, which structure affects the overall shape and weight. For scenes with high distance measuring requirements, the external distance measuring sensor is larger in size and not portable in the field.

Therefore, how to provide a target and bird watching scope that retains the traditional sizes of the target and bird watching scope and has a distance measuring function is a technical problem that needs to be urgently solved by a person skilled in the art.

### SUMMARY

In view of the above research status, the present disclosure provides a distance-measuring target and bird watching scope, which does not need to change the external size based on the structure of a traditional target and bird watching scope, and can realize the real-time distance measuring function while ensuring the aiming clarity of distant objects.

The a distance-measuring target and bird watching scope provided by present disclosure includes a receiving optical path, where in the receiving optical path, an objective lens group, a focusing objective lens, a reticle, a zoom front lens group, a zoom compensation lens group, a zoom rear lens group and a fixed eyepiece group are provided in sequence in the light beam propagation direction; and further includes: a laser emitting system, a laser receiving system and a liquid crystal display system,
where the laser emitting system includes a laser light emitting diode and an emitting lens arranged in the emission light path propagation direction, and the emitting lens is embedded in the objective lens group;
the laser receiving system is arranged in the receiving optical path at the front end of the fixed eyepiece group, and is used to convert the optical signal in the receiving optical path into an electrical signal through a beam splitter prism, obtain the target distance and display through the liquid crystal display system;
the liquid crystal display system is arranged in the receiving light path at the front end of the fixed eyepiece group, and is used to combine the display information containing the target distance to the receiving light path through a beam splitter prism, and transmit to the fixed eyepiece group.

Preferably, the laser receiving system includes a first beam splitter prism, a receiving lens and a laser receiver which are arranged in sequence in the light beam propagation direction, where the first beam splitter prism is used to split the receiving light path, reflect a part of light beams to the receiving lens to be received by the laser receiver, and transmit the remaining light beams to propagate in the original receiving light path propagation direction.

Preferably, the first beam splitter prism is located on the propagation light path between the focusing objective lens and the reticle.

Preferably, the liquid crystal display system forms an image at the second focal plane of the receiving light path, and the reticle is located at the first focal plane of the receiving light path; and the liquid crystal display system includes a transmissive-type LCD (liquid crystal display) or OLED (organic light emitting diode) liquid crystal.

Preferably, the liquid crystal display system forms an image at the second focal plane of the receiving light path, and the reticle is located at the first focal plane of the receiving light path; the liquid crystal display system includes a projection-type OLED liquid crystal, a display lens group and a second beam splitter prism which are sequentially arranged in the light beam propagation direction, where the display information containing the target distance in the OLED liquid crystal and imaged by the display lens group is combined into the receiving light path through the second beam splitter prism.

Preferably, the liquid crystal display system forms an image at the first focal plane of the receiving light path, and the reticle is located at the first focal plane of the receiving light path; and the liquid crystal display system includes a projection-type OLED liquid crystal and a display lens group arranged in sequence in the light beam propagation direction, where the display information containing the target distance in the OLED liquid crystal and imaged by the display lens group is combined into the receiving light path through the first beam splitting prism.

Preferably, the liquid crystal display system forms an image at the second focal plane of the receiving light path, and the reticle is located at the first focal plane of the receiving light path; the liquid crystal display system includes a projection-type OLED liquid crystal and a display lens group arranged in sequence in the light beam propagation direction, where the display information containing the target distance in the OLED liquid crystal and imaged by the display lens group is combined into the receiving light path through the first beam splitter prism; and the first beam splitter prism is located on the propagation light path between the zoom rear lens group and the fixed eyepiece group.

Preferably, it further includes a field diaphragm located between the zoom rear lens group and the fixed eyepiece group, and the field diaphragm is located at the second focal plane of the receiving light path.

Preferably, the lens edge of the objective lens group close to the focusing objective lens is provided with a U-shaped groove, and the emitting lens is embedded in the U-shaped groove; and the laser light emitting diode is located in the space between the objective lens group and the focusing objective lens.

Preferably, the magnification is changed by adjusting the optical axis position of the zoom compensation lens group between the zoom front lens group and the zoom compensation lens group.

Compared with the prior art, the present disclosure has the following beneficial effects.

The present disclosure can measure the target distance without destroying the traditional appearance design of the target and bird watching scope through built-in laser emission system, laser receiving system and liquid crystal display system. This not only makes the device more compact and portable, but also avoids the influence of the external distance measuring sensor on the overall shape.

The monocular zoom sight of the present disclosure can achieve a zoom range from 8 times to 40 times or even larger, meeting the observation requirements of targets at different distances. This flexibility enables the device to be suitable for multiple scenarios and capable of handling both close-range detailed observation and long-distance target acquisition.

The present disclosure combines different liquid crystal display solutions according to different environmental conditions and personal needs to achieve a target and bird watching scope capable of performing distance measuring under different environments and diversified distance measuring.

Since most of the target and bird watching scopes on the market currently only have the telescopic function and lack the distance measuring capability, and cannot effectively correct the trajectory, especially for military training and other fields, the present disclosure provides a product that retains the traditional appearance and size and further has the distance measuring function, filling the market gap and having a higher market demand potential.

### BRIEF DESCRIPTION OF DRAWINGS

In order to more clearly illustrate the embodiments of the present disclosure or the technical solutions in the prior art, the drawings required for use in the description of embodiments or the prior art are briefly introduced below. Obviously, the drawings described below are only embodiments of the present disclosure, and for a person ordinarily skilled in the art, other drawings may be obtained based on the provided drawings without creative work.

FIG. 1 is a schematic diagram of the optical path of a single beam splitter prism using a transmissive-type LCD or OLED liquid crystal provided by embodiments of the present disclosure;

FIG. 2 is a schematic diagram of the optical path of two beam splitting prisms using a projection-type OLED liquid crystal according to embodiments of the present disclosure;

FIG. 3 is a first schematic diagram of the optical path of a single beam splitter prism using a projection-type OLED liquid crystal provided by embodiments of the present disclosure;

FIG. 4 is a second schematic diagram of the optical path of a single beam splitter prism using a projection-type OLED liquid crystal provided by embodiments of the present disclosure;

FIG. 5 is a schematic diagram of the structure of a built-in emitting lens in an objective lens group provided by embodiments of the present disclosure;

FIG. 6 is a schematic diagram showing a reticle provided in embodiments of the present disclosure;

FIG. 7 is a schematic diagram showing distance display of an LCD or OLED liquid crystal provided by embodiments of the present disclosure;

FIG. 8 is a schematic diagram showing clear displaying of the reticle actually-observed by an observer and the display distance at the same time, provided by embodiments of the present disclosure;

FIG. 9 is a schematic diagram of the 8 times magnification structure of a traditional straight-tube-type target and bird watching scope provided by an embodiment of the present disclosure; and

FIG. 10 is a schematic diagram of the 40 times magnification structure of a traditional straight-tube-type target and bird watching scope provided by an embodiment of the present disclosure.

In the drawings, 1—objective lens group; 2—focusing objective lens; 3—first beam splitter prism; 4—receiving lens; 5—optical filter; 6—laser receiver; 7—reticle; 8—zoom front lens group; 9—zoom compensation lens group; 10—zoom rear lens group; 11—transmissive-type LCD or OLED liquid crystal; 12—fixed eyepiece group; 13—emitting lens; 14—laser light emitting diode; 15—display lens group; 16—OLED liquid crystal; 17—field diaphragm; 18—second beam splitter prism.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only some of the embodiments of the present disclosure, but not all of the embodiments. Based on the embodiments of the present disclosure, all other embodiments obtained by persons ordinarily skilled in the art without creative work are within the scope of protection of the present disclosure.

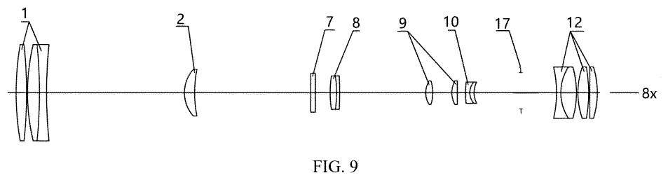

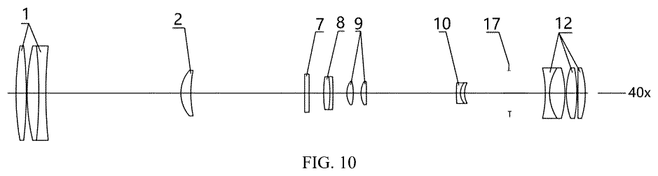

The present disclosure discloses a distance-measuring target and bird watching scope. A traditional straight-tube-type target and bird watching scope structure as shown in FIG. 9-FIG. 10, which is a monocular sight, includes a receiving optical path, where in the receiving optical path, an objective lens group 1, a focusing objective lens 2, a reticle 7, a zoom front lens group 8, a zoom compensation lens group 9, a zoom rear lens group 10 and a fixed eyepiece group 12 are provided in sequence in the light beam propagation direction. It should be noted that the objective lens group 1, the focusing objective lens 2, the reticle 7, the zoom front lens group 8, the zoom compensation lens group 9, the zoom rear lens group 10 and the fixed eyepiece group 12 are all located in a straight-tube-type housing.

Based on this structure, the embodiment of the present disclosure further includes a laser emitting system, a laser receiving system and a liquid crystal display system which are arranged in the straight-tube-type housing, where the laser emitting system includes a laser light emitting diode 14 and an emitting lens 13 arranged in the emitting light path propagation direction, and the emitting lens 13 is embedded in the objective lens group 1; the laser receiving system is arranged in the receiving light path at the front end of the fixed eyepiece group 12, and is used to convert the optical signal in the receiving light path into an electrical signal through a beam splitter prism, obtain the target distance and display it through the liquid crystal display system; and the liquid crystal display system is arranged in the receiving light path at the front end of the fixed eyepiece group 12, and is used to combine the display information containing the target distance to the receiving light path through a beam splitter prism, and transmit to the fixed eyepiece group 12.

The laser light emitting diode emits a laser, which is emitted to a measured target through the emitting lens 13. The laser beam reflected by the measured target is received by the objective lens, and is received by the laser receiving system through the focusing objective lens 2 and the beam splitter prism. The optical signal is converted into an electrical signal, and processed by the software to obtain the target distance, and displayed on the liquid crystal display system. The displayed information is received by the human eye through the fixed eyepiece group 12.

In a monocular sight, a target distance may be obtained by observing through the eyepiece. Through the built-in laser emitting system and laser receiving system, it may realize distance measuring and real-time distance displaying while aiming at the object, and realizes clear observation of targets at both long and close distances through the zoom design.

The monocular zoom sight can achieve a magnification range of 8 times to 40 times by adjusting the position of the zoom compensation lens group 9, and can achieve a larger magnification range if adjusted by the design.

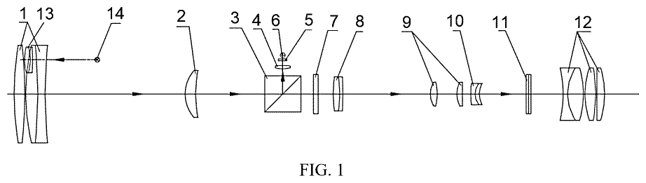

The present disclosure can cope with different environments and personnel needs through different liquid crystal display solutions, and perform a reasonable optical path design. FIG. 1 to FIG. 4 are examples of target and bird watching scopes under different liquid crystal display solutions.

In one embodiment, as shown in FIG. 1-FIG. 4, the laser receiving system includes a first beam splitter prism 3, a receiving lens 4 and a laser receiver 6 which are sequentially arranged in the light beam propagation direction, where the first beam splitter prism 3 is used to split the receiving light path, reflect a part of light beams to the receiving lens 4 to be received by the laser receiver 6, and transmit the remaining light beams to propagate in the original receiving light path propagation direction.

In this embodiment, an optical filter 5 is further provided between the receiving lens 4 and the laser receiver 6, which is selected as needed according to the ambient light. The receiving system shares the objective lens group 1 of the monocular sight, and the received signal is split by the first beam splitter prism 3, and then enters the laser receiver 6 through the receiving lens 4 and the optical filter 5.

In one embodiment, as shown in FIG. 1-FIG. 3, the first beam splitter prism 3 is located on the propagation light path between the focusing objective lens 2 and the reticle 7.

In this embodiment, as shown in FIG. 1, the liquid crystal display system forms an image at the second focal plane of the receiving light path, and the reticle 7 is located at the first focal plane of the receiving light path; the liquid crystal display system is a transmissive-type LCD or OLED liquid crystal 11, and the cementing layer of the first beam splitter prism 3 is coated with a beam splitting film that transmits visible light and reflects the laser band.

The observation and distance measuring processes include: observing the measured target with a monocular sight, adjusting the focusing objective lens 2, the fixed eyepiece group 12 and the zoom compensation lens group 9 to make the object and wires of the reticle 7 (wire reticle) clear at the same time, the laser light emitting diode 14 emitting a laser which is emitted after passing through the emitting lens 13 and reaches the measured target to reflect a light signal, the reflected light signal passing through the objective lens group 1, the focusing objective lens 2, the first beam splitter prism 3, the receiving lens 4, and the optical filter 5 and finally being received by the laser receiver 6, calculating the distance of the measured target through circuit and software processing according to the signal time difference between the emitting laser and the receiving laser, and the transmissive-type LCD or OLED liquid crystal 11 displaying the distance information, which is observed by the human eye through the fixed eyepiece group 12.

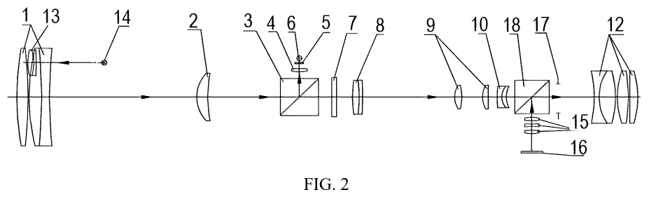

In this embodiment, as shown in FIG. 2, the liquid crystal display system forms an image at the second focal plane of the receiving light path, and the reticle 7 is located at the first focal plane of the receiving light path; the liquid crystal display system includes a projection-type OLED liquid crystal 16, a display lens group 15, and a second beam splitter prism 18 arranged in sequence in the light beam propagation direction, where the display information containing the target distance in the OLED liquid crystal imaged by the display lens group 15 is combined into the receiving light path through the second beam splitter prism 18, and the cementing layer of the second beam splitter prism 18 is coated with a beam splitting film that transmits visible light and reflects the laser band and the OLED display band.

The observation and distance measuring processes include: observing the measured target with a monocular sight, adjusting the focusing objective lens 2, the fixed eyepiece group 12 and the zoom compensation lens group 9 to make the object and wires of the reticle 7 (wire reticle) clear at the same time, the laser light emitting diode 14 emitting a laser, which is emitted after passing through the emitting lens 13 and reaches the measured target to reflect a light signal, the reflected light signal passing through the objective lens group 1, the focusing objective lens 2, the first beam splitter prism 3, the receiving lens 4, and the optical filter 5 and finally being received by the laser receiver 6, calculating the distance of the measured target through circuit and software processing according to the signal time difference between the emitting laser and the receiving laser, and displaying the distance information on the projection-type OLED liquid crystal 16, the projection-type OLED liquid crystal 16 forming an image at the position of the field diaphragm 17 through the display lens group 15 and the second beam splitter prism 18, to be observed by the human eye through the fixed eyepiece group 12.

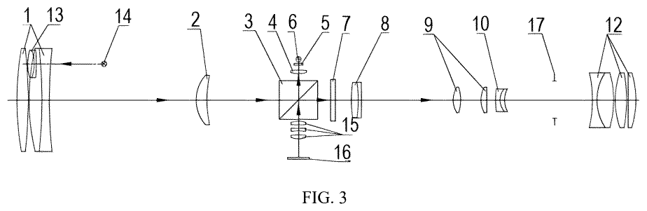

In this embodiment, as shown in FIG. 3, the liquid crystal display system forms an image at the first focal plane of the receiving light path, and the reticle 7 is located at the first focal plane of the receiving light path; the liquid crystal display system includes a projection-type OLED liquid crystal 16 and a display lens group 15 which are sequentially arranged in the light beam propagation direction, where the display information containing the target distance in the OLED liquid crystal imaged by the display lens group 15 is combined into the receiving light path through the first beam splitter prism 3, and the cementing layer of the first beam splitter prism 3 is coated with a beam splitting film which transmits visible light and reflects the laser band and the OLED display band.

It should be noted that the laser receiver 6 and the projection-type OLED liquid crystal 16 are distributed on two sides of the optical axis of the beam splitter prism.

The observation and distance measuring processes include: observing the measured target with a monocular sight, adjusting the focusing objective lens 2, the fixed eyepiece group 12 and the zoom compensation lens group 9 to make the object and wires of the reticle 7 (wire reticle) clear at the same time, the laser light emitting diode 14 emitting a laser which is emitted after passing through the emitting lens 13 and reaches the measured target to reflect a light signal, the reflected light signal passing through the objective lens group 1, the focusing objective lens 2, the first beam splitter prism 3, the receiving lens 4, and the optical filter 5 and finally being received by the laser receiver 6, calculating the distance of the target through circuit and software processing according to the signal time difference between the emitting laser and the receiving laser, displaying the distance information on the projection-type OLED liquid crystal 16, the projection-type OLED liquid crystal 16 forming an image at the position of the reticle 7 through the display lens group 15 and the first beam splitter prism 3, to be observed by the human eye through the zoom front lens group 8, the zoom compensation lens group 9, the zoom rear lens group 10 and the fixed eyepiece group 12.

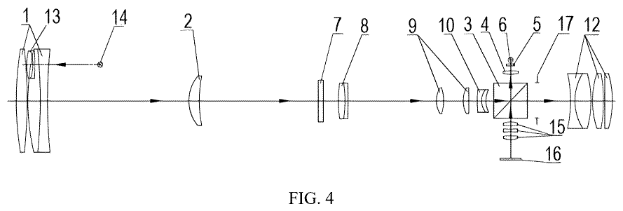

In one embodiment, as shown in FIG. 4, the liquid crystal display system forms an image at the second focal plane of the receiving light path, and the reticle 7 is located at the first focal plane of the receiving light path; the liquid crystal display system includes a projection-type OLED liquid crystal 16 and a display lens group 15 which are sequentially arranged in the light beam propagation direction, where the display information containing the target distance in the projection-type OLED liquid crystal 16 imaged by the display lens group 15 is combined into the receiving light path through the first beam splitter prism 3; the first beam splitter prism 3 is located on the propagation light path between the zoom rear lens group and the fixed eyepiece group 12, and the cementing layer of the first beam splitter prism 3 is coated with a beam splitting film which transmits visible light and reflects the laser band and the projection OLED display band.

It should be noted that the laser receiver 6 and the projection-type OLED liquid crystal 16 are distributed on two sides of the optical axis of the beam splitter prism.

The observation and distance measuring processes include: observing the measured target with a monocular sight, adjusting the focusing objective lens 2, the fixed eyepiece group 12 and the zoom compensation lens group 9 to make the object and wires of the reticle 7 (wire reticle) clear at the same time, the laser light emitting diode 14 emitting a laser which is emitted after passing through the emitting lens 13 and reaches the measured target to reflect a light signal, the reflected light signal passing through the objective lens group 1, the focusing objective lens 2, the reticle 7, the zoom front lens group 8, the zoom compensation lens group 9, the zoom rear lens group 10, the beam splitter prism, the receiving lens 4, and the optical filter 5 and finally being received by the laser receiver 6, calculating the distance of the measured target through circuit and software processing according to the signal time difference between the emitting laser and the receiving laser, displaying the distance information on the projection-type OLED liquid crystal 16, the projection-type OLED liquid crystal 16 forming an image at the position of the field diaphragm 17 through the display lens group 15 and the first beam splitter prism 3, to be observed by the human eye through the fixed eyepiece group 12.

In one embodiment, the field diaphragm 17 between the zoom rear lens group 10 and the fixed eyepiece group 12 is further included, and the field diaphragm 17 is located at the second focal plane of the receiving light path. As shown in FIG. 2 and FIG. 4, if one field diaphragm 17 is provided at the second focal plane, the projection-type OLED liquid crystal 16 display unit forms an image at the second focal plane position through the display lens group 15 and the beam splitter prism; and as shown in FIG. 3, can also form an image on the reticle 7 of the first focal plane through the display lens group 15 and the beam splitter prism, so as to achieve simultaneous clarity with the reticle 7.

It should be noted that, as shown in FIG. 1, the structured diaphragm is placed on the surface of the transmissive-type LCD or OLED liquid crystal 11 and then placed as a whole at the position of the second focal plane; and as shown in FIG. 2 to FIG. 4, for the projection-type OLED optical path structure, the structured diaphragm is placed alone at the position of the second focal plane.

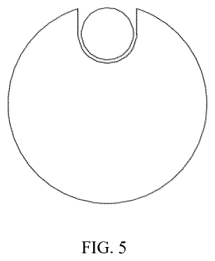

In one embodiment, as shown in FIG. 5, the lens edge of the objective lens group 1 close to the focusing objective lens 2 is provided with a U-shaped groove, and the emitting lens 13 is embedded in the U-shaped groove; and the laser light emitting diode 14 is located in the space between the objective lens group 1 and the focusing objective lens 2.

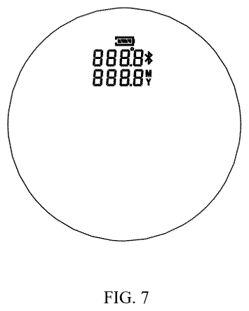

In one embodiment, as shown in FIG. 7, the transmissive-type LCD liquid crystal display unit is a transmissive-type black font display, and the OLED liquid crystal display unit is a luminous liquid crystal display unit, which may be a colored font such as a red font, a green font or other colored fonts, or may also display a dual-color font.

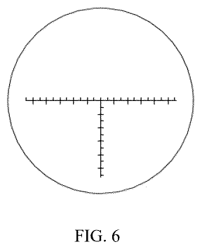

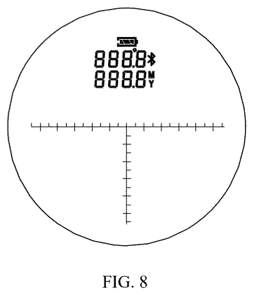

In one embodiment, as shown in FIG. 6-FIG. 8, the display content of the reticle 7 and the display content of the liquid crystal are at different positions in the field of view, which can be determined according to different requirements.

In one embodiment, the magnification is changed by adjusting the optical axis position of the zoom compensation lens group 9 between the zoom front lens group 8 and the zoom compensation lens group 9.

The reticle 7 is placed at the first focal plane of the optical path system, the field diaphragm 17 is placed at the second focal plane, the zoom front lens group 8 and the zoom rear lens group 10 are fixed in position, and the zoom focusing of the product from 8 to 40 times, or a larger magnification range, is achieved by moving the zoom compensation lens group 9. The working principle is to aim at a distant target surface or a bird, adjust the fixed eyepiece group 12 to make the reticle 7 clear, adjust the focusing objective lens 2 to make the object clear, and adjust the magnification according to the distance of the object for observation.

The above are detailed introduction to a distance-measuring target and bird watching scope provided by the present disclosure. Specific examples are used herein to illustrate the principles and implementations of the present disclosure. The description of the above embodiments is only used to help understand the method of the present disclosure and its core idea. Meanwhile, for those ordinarily skilled in the art, according to the idea of the present disclosure, there will be changes in both the specific implementations and application scopes. In summary, the content of this specification should not be understood as limiting the present disclosure.

Here, relational terms such as first and second, etc. are used only to distinguish one entity or operation from another entity or operation, and do not necessarily require or imply any such actual relationship or order between these entities or operations. Moreover, the terms “comprise”, “include” or any other variants thereof are intended to cover non-exclusive inclusion, so that a process, method, item or device including a series of elements includes not only those elements, but also other elements not explicitly listed, or also includes elements inherent to such process, method, item or device. In the absence of further restrictions, the elements defined by the phase “comprise a . . . ” do not exclude the presence of other identical elements in the process, method, item or device including the elements.

1. A distance-measuring target and bird watching scope, comprising a receiving optical path, wherein in the receiving optical path, an objective lens group, a focusing objective lens, a reticle, a zoom front lens group, a zoom compensation lens group, a zoom rear lens group and a fixed eyepiece group are provided in sequence in a light beam propagation direction; and further comprising: a laser emitting system, a laser receiving system and a liquid crystal display system,
wherein the laser emitting system comprises a laser light emitting diode and an emitting lens provided in an emission light path propagation direction, and the emitting lens is embedded in the objective lens group;
the laser receiving system is provided in a receiving optical path at a front end of the fixed eyepiece group, and configured to convert an optical signal in the receiving optical path into an electrical signal through a beam splitter prism, obtain a target distance and display through the liquid crystal display system; and
the liquid crystal display system is provided in the receiving light path at the front end of the fixed eyepiece group, and configured to combine display information containing the target distance to the receiving light path through the beam splitter prism, and transmit to the fixed eyepiece group.

2. The distance-measuring target and bird watching scope according to claim 1, wherein the laser receiving system comprises a first beam splitter prism, a receiving lens and a laser receiver which are sequentially provided in the light beam propagation direction, wherein the first beam splitter prism is configured to split the receiving light path, reflect a part of light beams to the receiving lens to be received by the laser receiver, and transmit remaining light beams to propagate in an original receiving light path propagation direction.

3. The distance-measuring target and bird watching scope according to claim 2, wherein the first beam splitter prism is located on a propagation light path between the focusing objective lens and the reticle.

4. The distance-measuring target and bird watching scope according to claim 1, wherein the liquid crystal display system is configured to form an image on a second focal plane of the receiving light path, and the reticle is located on a first focal plane of the receiving light path; and the liquid crystal display system includes a transmissive-type LCD or OLED liquid crystal.

5. The distance-measuring target and bird watching scope according to claim 1, wherein the liquid crystal display system is configured to form an image in a second focal plane of the receiving light path, and the reticle is located at a first focal plane of the receiving light path; and the liquid crystal display system comprises a projection-type OLED liquid crystal, a display lens group and a second beam splitter prism provided in sequence in the light beam propagation direction, wherein the display information containing the target distance in the OLED liquid crystal imaged by the display lens group is combined to the receiving light path through the second beam splitter prism.

6. The distance-measuring target and bird watching scope according to claim 2, wherein the liquid crystal display system is configured to form an image in a first focal plane of the receiving light path, and the reticle is located in the first focal plane of the receiving light path; and the liquid crystal display system comprises a projection-type OLED liquid crystal and a display lens group provided in sequence in the light beam propagation direction, wherein the display information containing the target distance in the OLED liquid crystal imaged by the display lens group is combined to the receiving light path through the first beam splitting prism.

7. The distance-measuring target and bird watching scope according to claim 2, wherein the liquid crystal display system is configured to form an image at a second focal plane of the receiving light path, and the reticle is located at a first focal plane of the receiving light path; the liquid crystal display system comprises a projection-type OLED liquid crystal and a display lens group provided in sequence in the light beam propagation direction, wherein the display information containing the target distance in the OLED liquid crystal imaged by the display lens group is combined to the receiving light path through the first beam splitter prism; and the first beam splitter prism is located on a propagation light path between the zoom rear lens group and the fixed eyepiece group.

8. The distance-measuring target and bird watching scope according to claim 1, further comprising a field diaphragm located between the zoom rear lens group and the fixed eyepiece group, and the field diaphragm is located at a second focal plane of the receiving light path.

9. The distance-measuring target and bird watching scope according to claim 1, where a lens edge of the objective lens group close to the focusing objective lens is provided with a U-shaped groove, and the emitting lens is embedded in the U-shaped groove; and the laser light emitting diode is located in a space between the objective lens group and the focusing objective lens.

10. The distance-measuring target and bird watching scope according to claim 1, wherein a magnification is changed by adjusting an optical axis position of the zoom compensation lens group between the zoom front lens group and the zoom compensation lens group.

11. The distance-measuring target and bird watching scope according to claim 2, wherein the liquid crystal display system is configured to form an image on a second focal plane of the receiving light path, and the reticle is located on a first focal plane of the receiving light path; and the liquid crystal display system includes a transmissive-type LCD or OLED liquid crystal.

12. The distance-measuring target and bird watching scope according to claim 3, wherein the liquid crystal display system is configured to form an image on a second focal plane of the receiving light path, and the reticle is located on a first focal plane of the receiving light path; and the liquid crystal display system includes a transmissive-type LCD or OLED liquid crystal.

13. The distance-measuring target and bird watching scope according to claim 2, wherein the liquid crystal display system is configured to form an image in a second focal plane of the receiving light path, and the reticle is located at a first focal plane of the receiving light path; and the liquid crystal display system comprises a projection-type OLED liquid crystal, a display lens group and a second beam splitter prism provided in sequence in the light beam propagation direction, wherein the display information containing the target distance in the OLED liquid crystal imaged by the display lens group is combined to the receiving light path through the second beam splitter prism.

14. The distance-measuring target and bird watching scope according to claim 3, wherein the liquid crystal display system is configured to form an image in a second focal plane of the receiving light path, and the reticle is located at a first focal plane of the receiving light path; and the liquid crystal display system comprises a projection-type OLED liquid crystal, a display lens group and a second beam splitter prism provided in sequence in the light beam propagation direction, wherein the display information containing the target distance in the OLED liquid crystal imaged by the display lens group is combined to the receiving light path through the second beam splitter prism.

15. The distance-measuring target and bird watching scope according to claim 3, wherein the liquid crystal display system is configured to form an image in a first focal plane of the receiving light path, and the reticle is located in the first focal plane of the receiving light path; and the liquid crystal display system comprises a projection-type OLED liquid crystal and a display lens group provided in sequence in the light beam propagation direction, wherein the display information containing the target distance in the OLED liquid crystal imaged by the display lens group is combined to the receiving light path through the first beam splitting prism.
